(19) United States
(12) Patent Application Publication
(10) Pub. No.: US 2011/0129735 A1
(43) Pub. Date: Jun. 2, 2011

(54) METHOD OF MANUFACTURING ACTIVE MATERIAL FOR A NON-AQUEOUS ELECTROLYTE BATTERY, NEGATIVE ELECTRODE FOR A NON-AQUEOUS ELECTROLYTE BATTERY, AND NON-AQUEOUS ELECTROLYTE BATTERY EMPLOYING THE NEGATIVE ELECTRODE

(75) Inventors: Mai Yokoi, Kobe-shi (JP); Yuu Takanashi, Kyoto-shi (JP); Masahide Miyake, Kobe-shi (JP); Yasuyuki Kusumoto, Kobe-shi (JP); Shigeki Matsuta, Kobe-shi (JP); Shinnosuke Ichikawa, Kobe-shi (JP)

(73) Assignee: SANYO ELECTRIC CO., LTD., Osaka (JP)

(21) Appl. No.: 12/956,667

(22) Filed: Nov. 30, 2010

(30) Foreign Application Priority Data
Nov. 30, 2009 (JP) 2009-272893
May 27, 2010 (JP) 2010-121197

(51) Int. Cl. H01M 4/485

(52) U.S. Cl. 429/231.2; 252/182.1

(57) ABSTRACT

A method of manufacturing an active material for a non-aqueous electrolyte battery, the active material containing a lithium-containing vanadium oxide, is provided. The active material for a non-aqueous electrolyte battery is washed with water or an acidic aqueous solution. By dissolving pentavalent vanadium, which is toxic, in water or an acidic aqueous solution, the pentavalent vanadium can be removed from the active material.

### BACKGROUND OF THE INVENTION

1. Field of the Invention

The present invention relates to a method of manufacturing an active material for a non-aqueous electrolyte battery, a negative electrode for a non-aqueous electrolyte battery, and a non-aqueous electrolyte battery employing the negative electrode. More particularly, the invention relates to removal of pentavalent vanadium, which is toxic, from the active material by washing the active material with water or an acidic aqueous solution.

2. Description of Related Art

Currently, non-aqueous electrolyte batteries with high energy density are used commonly as the power sources for various mobile devices. However, as the sizes of mobile devices are decreasing, non-aqueous electrolyte batteries having higher capacity per volume are desired.

Under such circumstances, lithium-containing vanadium oxide has attracted attention as a candidate for the active material for non-aqueous electrolyte batteries having high capacity per volume. While graphite, which has been conventionally used as an active material for the non-aqueous electrolyte battery, has a capacity per volume of about 830 mAh/cm³, calculated using true density, the lithium-containing vanadium oxide has a capacity of about 1200 mAh/cm³, calculated using true density.

Nevertheless, the lithium-containing vanadium oxide may contain pentavalent vanadium as an impurity. Since the pentavalent vanadium is known to be toxic to the human body, it is necessary to remove the pentavalent vanadium.

Japanese Published Unexamined Patent Application No. 2003-68305 discloses a method for inhibiting the generation of pentavalent vanadium. However, this method is not sufficient to prevent the generation of pentavalent vanadium. Moreover, although this method may inhibit the generation of pentavalent vanadium, it is not a method for removing the pentavalent vanadium that has been already generated.

It is known that when the non-aqueous electrolyte battery contains water, the non-aqueous electrolyte reacts with the water, causing capacity deterioration. For this reason, it has been believed among those skilled in the art that it is undesirable to wash the active material with water.

### BRIEF SUMMARY OF THE INVENTION

It is an object of the present invention to provide a method of manufacturing an active material for a non-aqueous electrolyte battery that is safe to the human body.

The present invention provides a method of manufacturing an active material for a non-aqueous electrolyte battery, the active material containing a lithium-containing vanadium oxide, a negative electrode for a non-aqueous electrolyte battery, and a non-aqueous electrolyte battery employing the negative electrode. The invention is characterized by washing the active material for a non-aqueous electrolyte battery with water or an acidic aqueous solution.

The present invention makes it possible to remove pentavalent vanadium, which is toxic, from the active material by dissolving the pentavalent vanadium in water or an acidic aqueous solution.

### BRIEF DESCRIPTION OF THE DRAWINGS

FIG. 1 illustrates XRD patterns for a material synthesized in Example 1 and a material obtained by washing the material synthesized in Example 1;

FIG. 2 is a schematic view illustrating a test cell used in the present invention;

FIG. 3 is a charge-discharge curve graph for the cell of Example 1;

FIG. 4 is a charge-discharge curve graph for the cell of Comparative Example 1;

FIG. 5 illustrates XRD patterns for a material synthesized in Example 3 and a material obtained by washing the material synthesized in Example 3;

FIG. 6 is an enlarged view of FIG. 5;

FIG. 7 is a charge-discharge curve graph for the cell of Example 3; and

FIG. 8 is a charge-discharge curve graph for the cell of Comparative Example 2.

### DETAILED DESCRIPTION OF THE INVENTION

The present invention provides a method of manufacturing an active material for a non-aqueous electrolyte battery, the active material containing a lithium-containing vanadium oxide, a negative electrode for a non-aqueous electrolyte battery, and a non-aqueous electrolyte battery employing the negative electrode. The invention is characterized by washing the active material for a non-aqueous electrolyte battery with water or an acidic aqueous solution.

Pentavalent vanadium, which is toxic, is removed from the active material by dissolving the pentavalent vanadium in water or an acidic aqueous solution.

An example of the active material that may be used in the present invention is an active material synthesized by mixing at least one lithium source including lithium carbonate, lithium acetate, lithium hydroxide, lithium nitrate, lithium oxide, lithium peroxide, and lithium oxalate with at least one vanadium source including vanadium sesquioxide (V₂O₃), vanadium tetroxide (V₂O₄), and vanadium pentoxide (V₂O₅) at a predetermined mole ratio. Li₁₊ₓV_{1-y}O₂ (−0.1≦x≦0.2, −0.1≦y≦0.2) containing Li₃VO₄, V₂O₅, or both is synthesized by the above described method.

The active material synthesized is washed with water or an acidic aqueous solution, and then dried in vacuum. Thereafter, the active material is kneaded together with a conductive agent and a binder agent to form a mixture, and then applied onto a current collector made of metal foil or the like. It should be noted that it is not necessary to add the conductive agent when using an active material that has excellent electrical conductivity.

Examples of the acidic aqueous solution include sulfuric acid, hydrochloric acid, nitric acid, phosphoric acid, boric acid, acetic acid, and formic acid. A preferable example is sulfuric acid. It is desirable that the acidic aqueous solution has a normality of from greater than 0 to 18, more preferably from greater than 0 to 1.2.

Examples of the conductive agent include carbonaceous substances, metals, semiconductors, metal carbides, and metallic compounds. When a material that intercalates and deintercalates lithium is used as the conductive agent, the capacity density of the negative electrode is increased. Examples of the carbonaceous substances include artificial graphite, natural graphite, acetylene black, and carbon black. Examples of the metals include tin, gallium, and aluminum. Examples of the semiconductors include silicon. Examples of the metal carbides include metal carbides having electrical conductivity, such as titanium carbide, tantalum carbide, tungsten carbide, and zirconium carbide.

When a conductive agent is added, the conductivity of the electrode cannot be sufficiently enhanced if the amount of the conductive agent added is too small. On the other hand, if the amount of the conductive agent added is too large, the capacity density of the electrode decreases because the relative proportion of the active material to the total mass of the active material, the conductive agent, and the binder agent becomes small. For this reason, it is desirable that the amount of the conductive agent be from 0.01 wt % to 90 wt %, more preferably from 30 wt % to 80 wt %, with respect to the total mass of the active material, the conductive agent, and the binder agent.

Examples of the binder agent include polytetrafluoroethylene (PTFE), polyvinylidene fluoride (PVdF), styrene-butadiene rubber (SBR), and polyacrylonitrile (PAN).

When the amount of the binder agent added is too small, the adhesion of the electrode and the mixture cannot be sufficiently enhanced. On the other hand, if the amount of the binder agent added is too large, the capacity density of the electrode decreases because the relative proportion of the active material to the total mass of the active material, the conductive agent, and the binder agent becomes small. For this reason, it is desirable that the amount of the binder agent be from 0.01 wt % to 30 wt %, with respect to the total mass of the active material, the conductive agent, and the binder agent.

Although the active material for a non-aqueous electrolyte battery manufactured according to the present invention may be used for both positive electrode and negative electrode, it is preferable that it is used for negative electrode.

Examples of the active material used for the counter electrode to the electrode using active material for a non-aqueous electrolyte battery manufactured according to the present invention include LiCoO₂, LiNiO₂, LiNi_{1/3}CO_{1/3}Mn_{1/3}O₂, LiMn₂O₄, LiFePO₄, LiMnPO₄, LiCoPO₄, and Li.

Examples of the solvent of the non-aqueous electrolyte used in the present invention include cyclic carbonic esters, chain carbonic esters, esters, cyclic ethers, chain ethers, nitriles, and amides. Examples of the cyclic carbonic esters include ethylene carbonate, propylene carbonate, butylene carbonate, trifluoropropylene carbonate, and fluoroethylene carbonate. Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated. Examples of the esters include methyl acetate, ethyl acetate, propyl acetate, methyl propionate, ethyl propionate, and γ-butyrolactone. Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether. Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether. Examples of the nitriles include acetonitrile. Examples of the amides include dimethylformamide. The above-listed solvents may be used in combination.

The lithium salt to be added to the non-aqueous solvent may be any lithium salt commonly used as the lithium salt in conventional non-aqueous electrolyte batteries. Examples include LiPF₆, LiBF₄, LiAsF₆, LiClO₄, LiCF₃SO₃, LiN(FSO₂)₂, LiN(CₗF₂ₗ₊₁SO₂)(CₘF₂ₘ₊₁SO₂) (where l and m are integers equal to or greater than 1), LiC(CₚF₂ₚ₊₁SO₂)(C_{q}F_{2q+1}SO₂)(CᵣF₂ᵣ₊₁SO₂) (where p, q, and r are integers equal to or greater than 1), Li[B(C₂O₄)₂], Li[B(C₂O₄)F₂], Li[P(C₂O₄)F₄], and Li[P(C₂O₄)₂F₂]. These lithium salts may be used either alone or in combination.

The manufacturing method of the present invention makes it possible to remove pentavalent vanadium, which is toxic to the human body, from the active material in a simple manner, and to improve the safety to the workers in the fabrication process of the non-aqueous electrolyte battery.

The amount of pentavalent vanadium in the active material is significantly reduces. The amount of V5+ in the active material after wash may be below 0.09 wt % based on the amount of active material before the wash. The amount of V5+ in the active material after wash may be below 0.045 wt % based on the amount of active material before the wash. The amount of V5+ in the active material after wash may be from 0.005 wt % to 0.045 wt % based on the amount of active material before the wash.

### EXAMPLES

Hereinbelow, the present invention is described in further detail based on specific examples thereof. It should be construed, however, that the present invention is not limited to the following examples.

### Example 1

A 1.22:1 mole ratio mixture of Li₂CO₃ and V₂O₃ was sintered under a nitrogen atmosphere at 1200° C. for 8 hours. Thereby, Li_{1.1}V_{0.9}O₂ serving as an active material was synthesized.

The synthesized active material was mixed with pure water (herein, the specific resistance of the pure water was 10 MΩcm or greater), dispersed by ultrasonic washing, and then separated from water by a centrifuge. This washing process was repeated 5 times, and then the resultant material was dried in vacuum at 35° C. for 5 hours, to obtain a washed lithium-containing vanadium oxide.

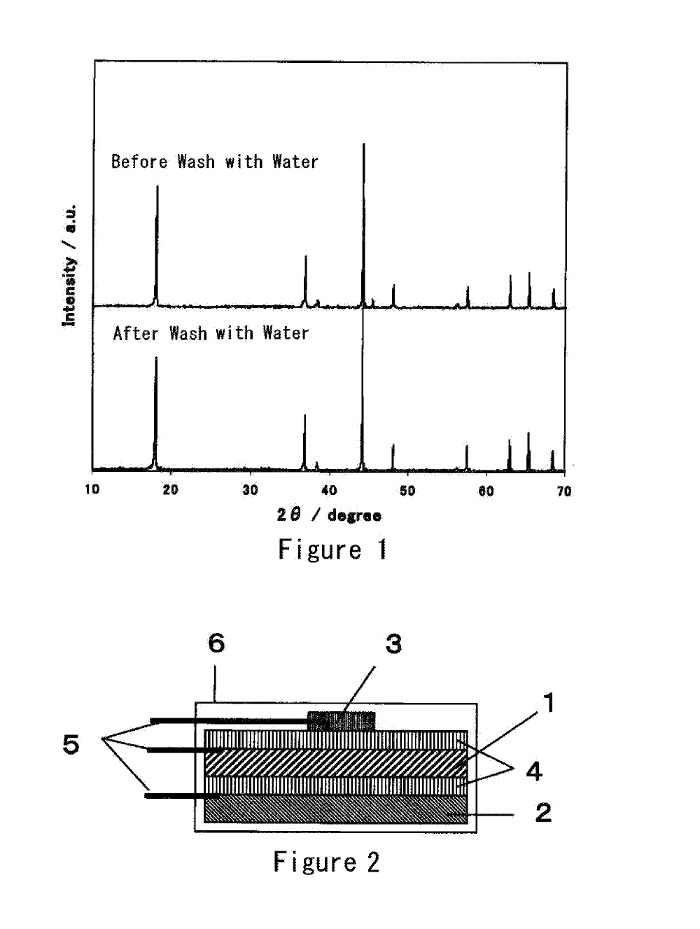

The active material that was synthesized but not washed and the active material that was washed were analyzed using an XRD apparatus. The results are shown in FIG. 1. The radiation source of the XRD apparatus used was CuKα rays condensed by a multilayer mirror. FIG. 1 shows that the synthesized material had a crystal structure equivalent to LiVO₂ belonging to the space group R-3m. The lattice constants obtained from the peak corresponding to the space group R-3m were: a=2.851 Å and c=14.720 Å (c/a=5.163) for the active material that was not washed, and a=2.852 Å and c=14.722 Å (c/a=5.162) for the active material that was washed. Thus, no significant difference was observed in lattice constant between the active material that was not washed and the active material that was washed. Moreover, no significant difference was observed in peak intensity ratio between the active material that was not washed and the active material that was washed. This demonstrates that the R-3m structure does not change even when the lithium-containing vanadium oxide is washed with pure water. From the lattice constants, it is concluded that the mole ratio Li/V of the lithium-containing vanadium oxides before and after the washing is from 1.05 to 1.21.

A slurry was prepared by mixing the active material washed with pure water, artificial graphite as the conductive agent, and PVdF as the binder agent in amounts of 32 wt %, 65 wt %, and 3 wt %, respectively, with respect to the total mass of the active material, the conductive agent, and the binder agent. The resultant slurry was applied onto a copper foil having a thickness of 10 μm by doctor blading, to prepare an electrode. The resultant electrode was cut out into a size of 2 cm×2 cm and was vacuum dried at 105° C. for 2 hours.

A test cell shown in FIG. 2 was fabricated under an argon gas atmosphere. An electrode prepared in the above-described manner was used for the working electrode 1, and metallic lithium was used for both the counter electrode 2 and the reference electrode 3. A separator 4 is interposed between each of the electrodes, and respective tab leads 5 are attached to the electrodes. An aluminum laminate 6 is used for the battery case, and the tab leads 5 protrude from the battery case. A mixed solvent of 3:7 volume ratio of ethylene carbonate (EC) and ethyl methyl carbonate (EMC) containing 1 mol/L of LiPF₆ is filled in the test cell.

Using the above described test cell, a charge-discharge test was conducted. The charge-discharge conditions were as follows. The end-of-charge potential was set at 0 V vs. Li/Li⁺, the end-of-discharge potential was set at 1.0 V vs. Li/Li⁺, and the charge-discharge current density was set at 20 mA/g.

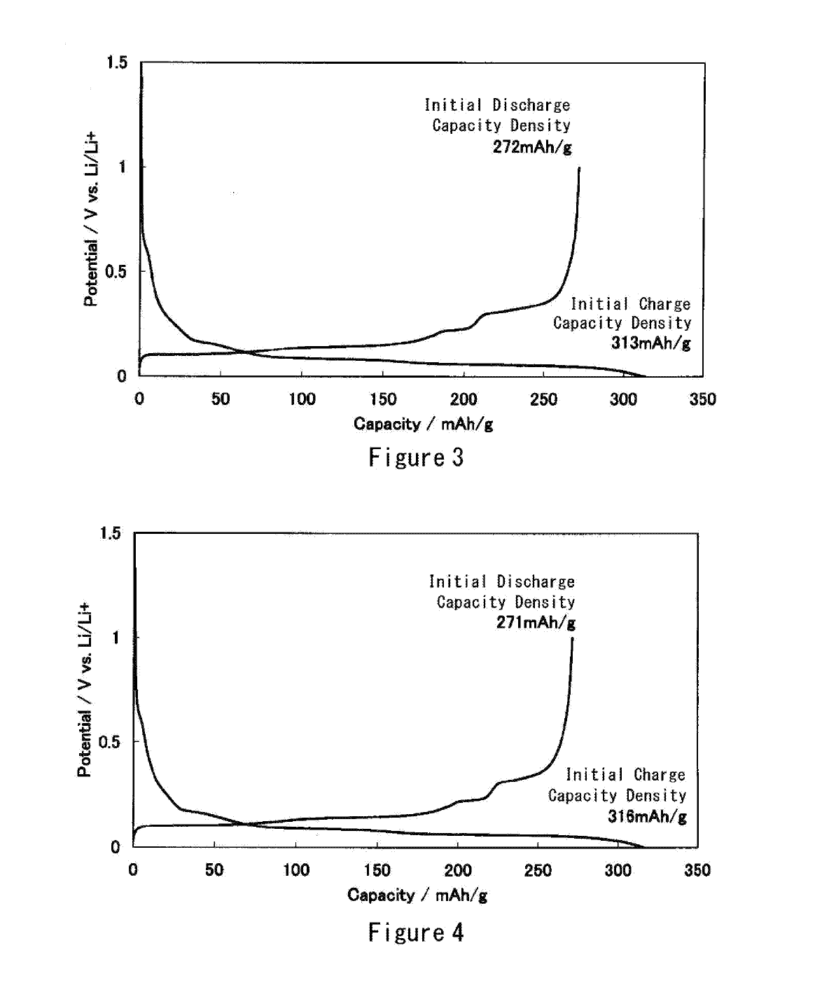

FIG. 3 illustrates the charge-discharge characteristics of the cell of Example 1. The initial charge capacity density was 313 mAh/g, and the initial discharge capacity density was 272 mAh/g. The initial charge capacity density and the initial discharge capacity density were obtained by dividing the initial charge capacity and the initial discharge capacity, respectively, of the cell by the total mass of the active material, the conductive agent, and the binder agent. Hereinbelow, the calculation of capacity density was conducted in the same manner as the above described method.

### Comparative Example 1

A test cell was fabricated in the same manner as described in Example 1, except that an active material that was synthesized in the same manner as described in Example 1 but not washed was used as the active material of the working electrode. Using the fabricated test cell, the charge-discharge test was conducted.

FIG. 4 illustrates the charge-discharge characteristics of the cell of Comparative Example 1. As a result of the test, it was found that the initial charge capacity density of the test cell was 316 mAh/g and the initial discharge capacity density was 271 mAh/g.

As seen from Table 1, no significant difference in initial discharge capacity density was observed between Example 1, which was washed with water, and Comparative Example 1, which was not washed with water. From the results, it is evident that the lithium-containing vanadium oxide that contributes to the capacity does not dissolve in water. It is also clear that washing the active material with water has no adverse effect on the capacity.

TABLE 1

| | Initial discharge |
|---|---|
| | capacity density |
| Example 1 | 272 |
| Comparative Example 1 | 271 |

### Example 2

An active material was synthesized in the same manner as described in Example 1, but was not washed. 200 mg of the active material synthesized but not washed was mixed with 80 mL of pure water, and stirred at room temperature for 1 hour. Thereafter, 80 mL of pure water was further added to the mixture, and the mixture was subjected to suction filtration. Thereafter, 80 mL of sulfuric acid having a normality of 18 was added to 80 mL of the filtrate, and redox titration was carried out using 0.005 mol/L SnCl₂-6N H₂SO₄, to determine the amount of V⁵⁺ in the filtrate. In addition, the amount of V⁵⁺ in the active material remaining on the filter paper was also determined in the same manner as described above.

Table 2 shows the results of the analysis on the amount of V⁵⁺ in the filtrate and the residue. The amounts of V⁵⁺ determined by the redox titration were 0.42 mg for the filtrate and less than the lower detection limit (0.09 mg) for the residue. This means the amount of V⁵⁺ in the active material after the wash was less than 0.045 wt % of the amount of the active material before the wash. The results of this analysis demonstrate that the amount of pentavalent vanadium in the active material is significantly reduced by washing the active material containing the lithium-containing vanadium oxide.

TABLE 2

| | Amount of |
|---|---|
| | V⁵⁺ determined |
| | by titration (mg) |
| Filtrate | 0.42 |
| Residue | 0.09> |

Thus, it is evident that by washing the active material containing the lithium-containing vanadium oxide with water, the lithium-containing vanadium oxide in the active material that contributes to the capacity is not removed, but the amount of the pentavalent vanadium, which is toxic, can be significantly reduced. The use of water has an advantage of easier handling than in the case of using an acidic aqueous solution.

### Example 3

An active material was synthesized in the same manner as described in Example 1, but was not washed. 2 g of the active material synthesized but not washed was mixed with 800 mL of sulfuric acid having a normality of 1.2, and stirred at room temperature for 1 hour. Thereafter, the mixture was subjected to suction filtration. The filtrated sample was dried in vacuum at room temperature for 12 hours, and further dried at 40° C. for 2 hours.

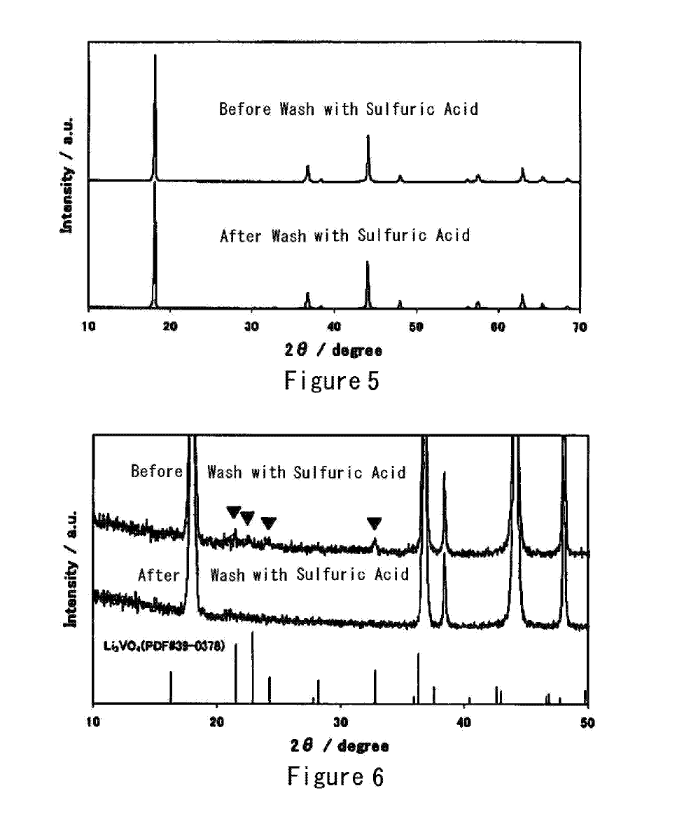

The active material that was synthesized but not washed and the active material that was washed were analyzed using an XRD apparatus. The results are shown in FIG. 5. The radiation source of the XRD apparatus used was CuKα rays monochromatized by curved graphite. FIG. 5 shows that the synthesized material had a crystal structure equivalent to LiVO₂ belonging to the space group R-3m. The lattice constants obtained from the peak corresponding to the space group R-3m were: a=2.848 Å and c=14.713 Å (c/a=5.166) for the active material that was not washed, and a=2.848 Å and c=14.709 Å (c/a=5.165) for the active material that was washed. Thus, no significant difference was observed in lattice constant between the active material that was not washed and the active material that was washed. Moreover, no significant difference was observed in peak intensity ratio between the active material that was not washed and the active material that was washed. This demonstrates that the R-3m structure does not change even when the lithium-containing vanadium oxide is washed with sulfuric acid having a normality of 1.2. From the lattice constants, it is concluded that the mole ratio Li/V of the lithium-containing vanadium oxides before and after the washing is from 1.05 to 1.21.

FIG. 6 is an enlarged view of FIG. 5. From FIG. 6, it is concluded that the Li₃VO₄ that is believed to be contained in the sample before the washing was removed by the washing.

A test cell was fabricated in the same manner as described in Example 1 above, except that the slurry was prepared by mixing the active material washed with sulfuric acid having a normality of 1.2, artificial graphite as the conductive agent, and PVdF as the binder agent in amounts of 30 wt %, 65 wt %, and 5 wt %, respectively, with respect to the total mass of the active material, the conductive agent, and the binder agent. Using the test cell, the charge-discharge test was conducted.

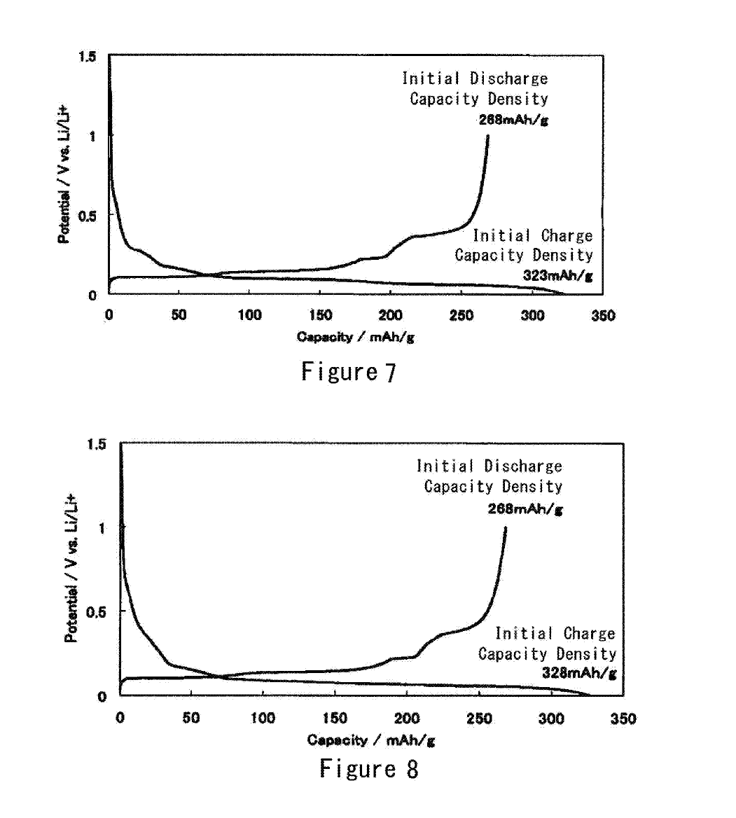

FIG. 7 illustrates the charge-discharge characteristics of the cell of Example 3. The initial charge capacity density was 323 mAh/g, and the initial discharge capacity density was 268 mAh/g.

### Comparative Example 2

A test cell was fabricated in the same manner as described in Example 3, except that an active material that was synthesized in the same manner as described in Example 3 but not washed was used as the active material of the working electrode. Using the fabricated test cell, the charge-discharge test was conducted.

FIG. 8 illustrates the charge-discharge characteristics of the cell of Comparative Example 2. As a result of the test, it was found that the initial charge capacity density of the test cell was 328 mAh/g and the initial discharge capacity density was 268 mAh/g.

As seen from Table 3, no significant difference in initial discharge capacity density was observed between Example 3, which was washed with washed with sulfuric acid having a normality of 1.2, and Comparative Example 2, which was not washed. From the results, it is evident that the lithium-containing vanadium oxide that contributes to the capacity does not dissolve in the sulfuric acid having a normality of 1.2. It is also clear that washing the active material with the sulfuric acid having a normality of 1.2 has no adverse effect on the capacity.

TABLE 3

| | Initial discharge |
|---|---|
| | capacity density |
| | (mAh/g) |
| Example 3 | 268 |
| Comparative Example 2 | 268 |

### Reference Example 1

An active material was synthesized in the same manner as described in Example 1, but was not washed. 50 mg of the active material synthesized but not washed was mixed with 40 mL of pure water, and stirred at room temperature for 1 hour. Thereafter, the dissolving conditions were observed by visual observation. The solutions in which no turbidity or powder was observed was determined as “dissolved,” and the rest were determined as “undissolved.” Then, the solutions were filtered with a membrane filter having a pore size of 0.45 μm, and the amount of vanadium in the filtrate of each solution was measured by ICP-AES. Also, the solubility of vanadium was calculated according to Equation (1). Next, the same experiment was conducted using the sulfuric acid having a normality of 1.2 and the sulfuric acid having a normality of 18N in place of pure water. The results of the experiments are shown in Table 4. The numerical values in parentheses in the table indicate the solubility of vanadium calculated according to Equation (1).

Solubility of vanadium (%)=the amount of vanadium in filtrate/the amount of vanadium in Li_{1.1}V_{0.9}O₂ before filtration×100 Eq. (1)

### Reference Example 2

The amount of vanadium in the filtrate was measured by ICP-AES in the same manner as described in Reference Example 1, except that V₂O₅ was used as the vanadium oxide containing pentavalent vanadium in place of Li_{1.1}V_{0.9}O₂. Also, the solubility of vanadium was calculated according to Equation (2). The results are shown in Table 4 below.

Solubility of vanadium (wt %)=the amount of vanadium in filtrate/the amount of vanadium in V₂O₅ before filtration×100 Eq. (2)

TABLE 4

| | Reference Example 1 | Reference Example 2 |
|---|---|---|
| | Li_{1.1}V_{0.9}O₂ | V₂O₅ |
| Pure water | Undissolved (0.7 wt %) | Undissolved (—) |
| Sulfuric acid 1.2N | Undissolved (0.8 wt %) | Dissolved (100 wt %) |
| Sulfuric acid 18N | Undissolved (—) | Dissolved (—) |

The results shown in Table 4 indicate that almost no Li_{1.1}V_{0.9}O₂ dissolves in pure water, the sulfuric acid having a normality of 1.2, or the sulfuric acid having a normality of 18. The results also indicate that V₂O₅ dissolves in the sulfuric acid having a normality of 1.2 and the sulfuric acid having a normality of 18, but it does not dissolve in pure water. These results demonstrate that by washing the active material containing a lithium-containing vanadium oxide with sulfuric acid, V₂O₅ in the lithium-containing vanadium oxide can be removed.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A method of manufacturing an active material for a non-aqueous electrolyte battery, the active material containing a lithium-containing vanadium oxide, comprising:
washing the active material with water or an acidic aqueous solution.

2. The method according to claim 1, wherein the lithium-containing vanadium oxide comprises Li₁₊ₓV_{1-y}O₂, where −0.1≦x≦0.2 and −0.1≦y≦0.2.

3. The method according to claim 1, comprising washing with the acidic aqueous solution, wherein the acidic aqueous solution is a sulfuric acid having a normality of from greater than 0 to 18.

4. The method according to claim 3, wherein the acidic aqueous solution is a sulfuric acid having a normality of from greater than 0 to 1.2.

5. The method according to claim 1, comprising removing pentavalent vanadium by washing the active material with water or an acidic aqueous solution.

6. The method according to claim 1, comprising washing the active material with water.

7. A negative electrode for a non-aqueous electrolyte battery, comprising:
a current collector; and
a negative electrode active material, wherein the negative electrode active material is manufactured by the method according to claim 1.

8. A negative electrode for a non-aqueous electrolyte battery, comprising:
a current collector; and
a negative electrode active material, wherein the negative electrode active material is manufactured by the method according to claim 2.

9. A negative electrode for a non-aqueous electrolyte battery, comprising:
a current collector; and
a negative electrode active material, wherein the negative electrode active material is manufactured by the method according to claim 3.

10. A negative electrode for a non-aqueous electrolyte battery, comprising:
a current collector; and
a negative electrode active material, wherein the negative electrode active material is manufactured by the method according to claim 4.

11. A negative electrode for a non-aqueous electrolyte battery, comprising:
a current collector; and
a negative electrode active material, wherein the negative electrode active material is manufactured by the method according to claim 5.

12. A negative electrode for a non-aqueous electrolyte battery, comprising:
a current collector; and
a negative electrode active material, wherein the negative electrode active material is manufactured by the method according to claim 6.

13. A positive electrode for a non-aqueous electrolyte battery, comprising:
a current collector; and
a positive electrode active material, wherein the positive electrode active material is manufactured by the method according to claim 1.

14. A non-aqueous electrolyte battery comprising: a positive electrode; an electrolyte; a separator; and the negative electrode according to claim 7.

15. A non-aqueous electrolyte battery comprising: a positive electrode; an electrolyte; a separator; and the negative electrode according to claim 8.

16. A non-aqueous electrolyte battery comprising: a positive electrode; an electrolyte; a separator; and the negative electrode according to claim 9.

17. A non-aqueous electrolyte battery comprising: a positive electrode; an electrolyte; a separator; and the negative electrode according to claim 10.

18. A non-aqueous electrolyte battery comprising: a positive electrode; an electrolyte; a separator; and the negative electrode according to claim 11.

19. A non-aqueous electrolyte battery comprising: a positive electrode; an electrolyte; a separator; and the negative electrode according to claim 12.

20. A non-aqueous electrolyte battery comprising: a negative electrode; an electrolyte; a separator; and the positive electrode according to claim 13.
